(19) United States
(12) Patent Application Publication
(10) Pub. No.: US 2003/0213845 A1
(43) Pub. Date: Nov. 20, 2003

(54) Device for identifying and storing at least one object equipped with a transponder

(76) Inventors: Wilfried Hermann, Gehrden (DE); Anatoli Stobbe, Barsinghausen (DE)

Correspondence Address: WILLIAM COLLARD, COLLARD & ROE, P.C., 1077 NORTHERN BOULEVARD, ROSLYN, NY, 11576, US

(21) Appl. No.: 10/423,635

(22) Filed: Apr. 25, 2003

(30) Foreign Application Priority Data
Apr. 26, 2002 (DE) 102 18 850.5

(51) Int. Cl. G06F 17/60

(52) U.S. Cl. 235/385

(57) ABSTRACT

A device for identifying and storing at least one object equipped with a transponder has a receiving shaft combined with an antenna of a reader and a locking device for the object. The antenna of the reader and an electromagnetic actuator of the locking device have a common coil, which is coupled both to a sender and receiver of the reader and to a regulatable energy source of the electromagnetic actuator.

### CROSS REFERENCE TO RELATED APPLICATIONS

Applicants claim priority under 35 U.S.C. §119 of German Application No. 102 18 850.5 filed Apr. 26, 2002.

### BACKGROUND OF THE INVENTION

1. Field of the Invention

The present invention relates to a device for identifying and storing at least one object equipped with a transponder, by a receiving shaft combined with an antenna of a reader with a locking device for the object.

2. The Prior Art

U.S. Pat. No. 6,131,808 A discloses a system and device for retaining objects. Here storage shafts in the form of a matrix, into which the objects can be inserted, are arranged in a lockable cabinet. The objects serve as tags for keys and contain a memory chip, which is connected in the storage shaft via electric contacts to a reader. In this way the data contained in the memory chip can be read and the objects can thus be identified. The objects have recesses, in which the latches of an armature of an electromagnet lock into place in the inserted state and lock the objects against unauthorized removal.

To remove objects a code must be input via a keyboard, which allows the lock to be triggered by an assigned electromagnet, so that the object can be withdrawn from the storage shaft.

The earlier German patent application 101 13 072.4 describes another system for storing and outputting objects. The object including a transponder with data memory which can be read wirelessly, rather than having a galvanically readable memory chip.

### SUMMARY OF THE INVENTION

The object of the invention is to create a device for identifying and storing at least one object equipped with a transponder, which enables a cost-effective and compact structure for both the locking device and the antenna for reading the transponder.

This object is solved according to the invention by a device for identifying and storing at least one object equipped with a transponder by a receiving shaft, wherein the antenna of the reader and an electromagnetic actuator of the locking device for the object have a common coil which is coupled to both a sender and receiver of the reader as well as to a regulatable energy source of the electromagnetic actuator.

Further developments and advantageous configurations are discussed below.

By using a common coil for the antenna of the reader and the electromagnetic actuator of the locking device, preparing and arranging a separate coil for the antenna of the reader and the electromagnetic actuator for each receiving shaft is superfluous. This arrangement reduces both the number of structural components and the number of connectors to the sender and receiver of the reader and to a controllable energy source of the electromagnetic actuator.

Decreasing the number of structural elements reduces the structural size, allowing a lesser distance and thus a greater density of the receiving shafts per surface unit or at least a lesser structural depth, in particular when several receiving shafts are arranged. Furthermore, only one compact element per receiving shaft is used, radically lowering costs for such a device.

Preferably, the coil is coupled galvanically to an energy source including a direct-current or direct-voltage source or coupled galvanically or inductively to the energy source including a low-frequency alternating-current or alternating-voltage source, and is coupled to the sender and receiver of the reader inductively or capacitively.

This enables both selective and simultaneous use of a coil as actuator and antenna without opposing disruption or impairment.

According to a further embodiment, the electromagnetic actuator includes a single-aperture core arranged radially inside the coil, a yoke overlapping the coil and an armature magnetically attracted to the yoke, whereby at least the single-aperture core and the yoke have interruptions on the periphery, such that with a direct field or a low-frequency alternating field they focus the magnetic flow, generated by the coil, and thus attract the armature, but do not deflect a high-frequency alternating field, or do so only incidentally.

This arrangement including single-aperture core, yoke and armature functions magnetically as actuator. However, without this arrangement where the coil operates as antenna, the coil being utilized and the other components would be unusable for reading the transponder. Without this embodiment as antenna, at least the single-aperture core and the yoke would deflect the high-frequency magnetic alternating field, so that a sufficiently high-frequency magnetic alternating field could not build up inside the coil to be able to communicate with the transponder and be able to read the transponder data.

Due to the embodiment of single-aperture core and yoke when the coil is operated as an antenna, an electromagnetic short circuit is avoided through the single-aperture core and the yoke on account of the electrical open winding, and consequently damping of the electromagnetic field of a coil is avoided when used as an antenna. The coil is thus optimized simultaneously for operation as electromagnetic actuator and as antenna.

In a further embodiment, the locking device also includes a pivoting lever with a latch, which has the following function.

When the object is inserted into the receiving shaft the lever reaches a latch position, in which the latch engages in a recess of the object and when it is in the latch position the armature grips the lever and fixes it in the magnetically inactive state of the coil, therefore without being supplied by direct current or direct voltage. When the armature is attracted and the object is withdrawn, due to detachment of the latch the pivoting lever disengages from the recess of the object and moves into a release position. The pivoting lever behaves bistably, that is, both abovementioned end positions are stable when the actuator is in the currentless state.

In this embodiment the pivoting lever assuming locking engagement is actuated by the object itself. However, with the armature the lever is fixed only in a latch position. Because less force is required to initiate and release fastening of the lever than to actuate the lever, the actuator can be configured for minimal actuation forces. Therefore, the required size of the coil and output of the energy source can be minimized because of the lesser available electromagnetic output of the actuator. Since the pivoting lever behaves bistably in both end positions, its state remains intact in the event of a system breakdown.

According to a further embodiment, the armature can be swung away from the yoke by gravity or spring force when the coil is in the magnetic inactive state, therefore without supply by direct current or direct voltage. The coil must then be powered to attract the armature only by direct current or direct voltage, while the armature is released automatically when the coil is in the inactive state.

Moreover the lever can swing into a stable release position via gravity or spring force when in the unactuated or unfixed state.

Then it is possible to push an object into the end position in the receiving shaft without previously having to release the lever.

When the actuator is in a currentless or voltage-free state the locking device can have stable states both in a release position and in a stop position. The actuator must then be briefly actuated to transfer the locking device into the release position, enabling economic operation and minimal thermal load of the current-bearing components.

Alternatively the locking device can have a stop position as stable state when the actuator is in the currentless or voltage-free state. It can assume a time-limited release position when the actuator is supplied with current or voltage and then automatically return to the stop position. The result of this is that the stop position is also taken up automatically in the event of a system failure.

According to another embodiment the position of the object in the receiving shaft can be monitored by continual or intermittent communication of the transponder with the reader.

In the process the presence and absence of objects can be regulated continuously and unauthorized entry can be recognized whenever the locking becomes powerful or is overcome by mechanical handling and an object is removed.

In addition the position of the object in the receiving shaft and/or the position of the lever and/or the position of the armature can be monitored by sensors. This measure offers the option of regulating the presence and absence of an object and also of monitoring the proper function of the constituents making up the locking device.

With several receiving shafts the coils and optionally also the sensors can be coupled to the sender and receiver of the reader and the regulatable energy source via a multiplexer, including a controller and the coils and electronic switches assigned to the sensors.

Several receiving shafts can be monitored and controlled with one and the same regulatable energy source as well as one and the same sender and receiver of the reader. In the case of optional sensors these can also be activated and evaluated for each receiving shaft being maintained.

According to a further embodiment, the object can be relocked after unlocking but remaining in the receiving shaft following a time delay. This prevents later unauthorized removal of the object in the event of previous operational error.

When an object is returned, a transponder number of the object can be read by means of the reader and a stop position of the object can be detected by means of the sensor, when first inserted into a receiving shaft. The transponder number and the state detected by the sensor are then transferred to a controller. This enables identification by transponder number and also determining of a proper stop.

With an illegible transponder number or non-stopped position of the object, the controller can indicate a fault condition. With both a legible transponder number and a stop position of the object, no indication of fault is generated.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1a shows a section through a receiving shaft with a locking device and an object locked therein.

FIGS. 1b and 1c are side and end views, respectively, of a pivoting lever used in the embodiment of FIG. 1a.

FIGS. 2a-2f illustrate a yoke in side and axial views (FIGS. 2a and 2b), a single-aperture core in longitudinal section and axial views (FIGS. 2c and 2d) and an armature in side and axial views (FIGS. 2e and 2f) of the electromagnetic actuator used in the embodiment of FIG. 1a.

FIGS. 3a and 3b illustrate in detail the actuator used in the embodiment of FIG. 1a including a single-aperture core, yoke and armature in side and axial views, respectively.

FIG. 4 is a basic circuit diagram of the electrical and electronic components of the device.

### DETAILED DESCRIPTION OF PREFERRED EMBODIMENTS

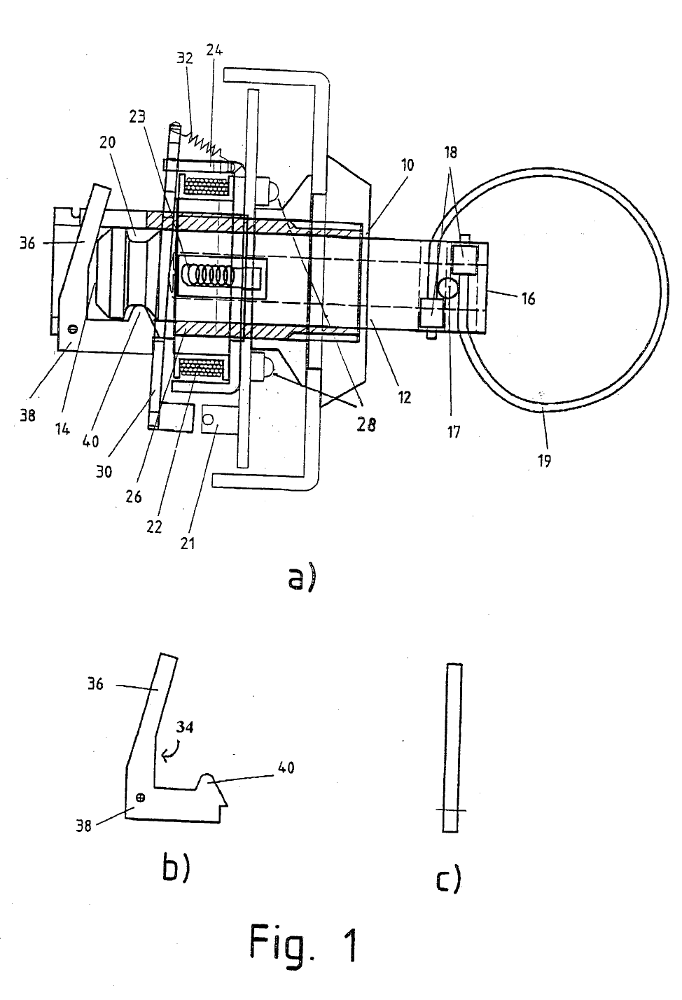

Referring to the drawings, FIG. 1 illustrates a receiving shaft 10 of the device with a locking device and an object 12 inserted into and locked in receiving shaft 10. Receiving shaft 10 and object 12 are cylindrical in shape. The free left (in the diagram) end 14 of object 12 is chamfered. At a distance from this end is an annular recess or circular groove 20 with likewise chamfered flanks. Arranged inside object 12 is a transponder with an antenna coil 23, whose axis is aligned parallel to the longitudinal central axis of object 12. The free right (in the diagram) end 16 of object 12 includes at least a bore 18, which for example is suitable for taking up a key ring or a wire coil 19 with keys attached thereto.

When this is in the form of a wire coil 19 its ends are thickened and safeguarded from being removed from bores 18 by a stop pin 17 driven in transversely. Stop pin 17 is here driven into a blind bore and cannot be removed without difficulty.

Receiving shaft 10 is enclosed by a cylindrical coil 22, which serves simultaneously as antenna for a sender and receiver of a reader 42 of the device and also serves to actuate the actuator of the locking device. A single-aperture core 26 and a yoke 24 serve to focus the magnetic direct field of coil 22. Whereas single-aperture core 26 is arranged radially and axially inside coil 22, yoke 24 is located on a front end of coil 22 and then continues on the exterior of coil 22. Arranged on one leg of yoke 24 is a pivoting armature 30. Armature 30 is prestressed by a spring 32 and is located in a position raised from yoke 24.

The locking device also includes a pivoting lever 34 shown in FIG. 1b including an upright leg 36 and a supine leg 38. Upright leg 36 projects axially into the end of receiving shaft 10. Supine leg 38 is fitted with a latch 40, which can be engaged in a circular groove 20 of object 12. In this position, lever 34 is overlapped by raised armature 30 and is thus fixed in a latch position. On a support attached to yoke 24 a sensor 21 is arranged, which detects the position of armature 30, via a lug attached to armature 30, and thus indirectly the exact position of object 12.

Twelve LEDs 28, which are regulated by a controller, are assigned to the receiving shafts to optically signal the position of receiving shaft 10 and the correct or faulty stopping of the object.

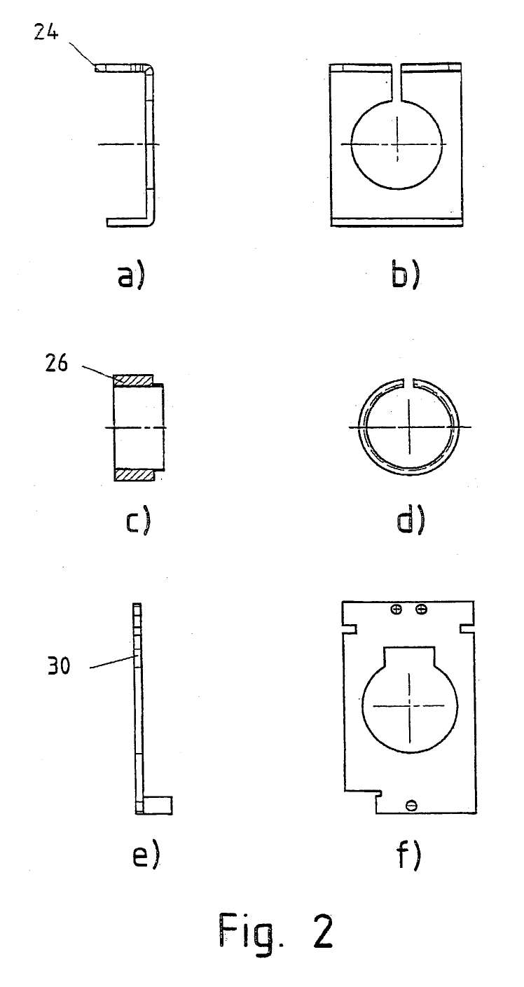

The detailed views in FIGS. 2a-2f show a side elevation at FIG. 2a and an axial view of the yoke 24 at FIG. 2b, at FIG. 2c a longitudinal section and at FIG. 2d an axial view of single-aperture core 26, at FIG. 2e a side elevation and at FIG. 2f an axial view of armature 30. Yoke 24 and single-aperture core 26 exhibit interruptions, here in the form of an axially aligned longitudinal slot.

Due to their placement directly adjacent to coil 22 in a magnetic direct field or a low-frequency alternating field, yoke 24 and single-aperture core 26 focus the magnetic flow generated by coil 22. But in a high-frequency alternating field they would also represent a winding coupled with the coil transformationally, which deflects the high-frequency alternating field and detunes the resonance frequency of an oscillating circuit formed by coil 22 and a condenser, not shown here. The interruptions on the circumference of yoke 24 and single-aperture core 26 in the form of slots result in an electric open winding parallel to the winding of coil 22 and antenna coil 23 of the transponder, avoiding deflection of the high-frequency alternating field and detuning of the resonance frequency. Since armature 30 in the failed state is coupled only very loosely to coil 22 and thus to the high-frequency alternating field, interruption of the periphery does not occur.

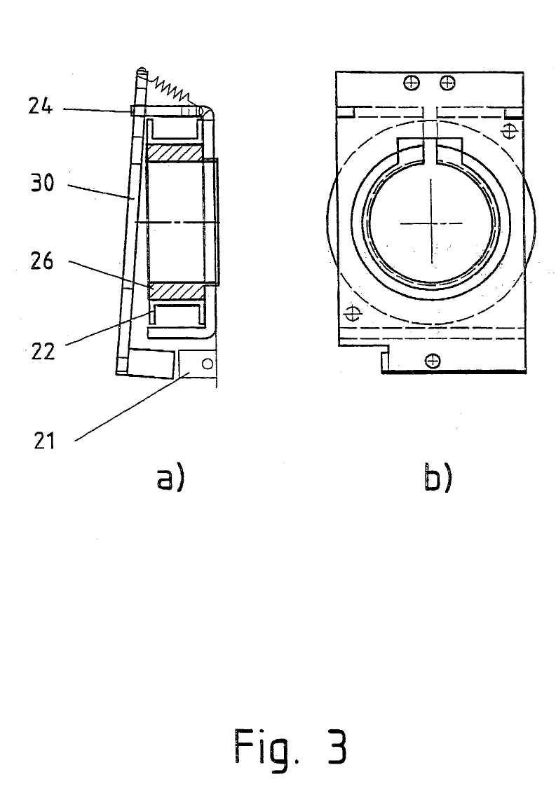

FIGS. 3a-3b show at FIG. 3a a detailed view of the mounted actuator including a single-aperture core, yoke and armature in side elevation and at FIG. 3b in axial view. Compared to FIG. 1a, in FIG. 3a the receiving shaft with its additional components and the object are not illustrated for reasons of clarity.

Reference is made to FIG. 1a for further description of function. When receiving shaft 10 is free it is assumed that lever 34 rests in a release position. Here supine leg 38 is positioned with latch 40 outside the interior of receiving shaft 10 and upright leg 36 is pivoted further to the right, as compared to the position illustrated in FIG. 1a. When an object 12 is inserted, the free left end 14 of object 12 contacts upright leg 36. Further insertion pivots upright leg 36 so that latch 40 on supine leg 38 enters circular groove 20 of object 12. In this position, armature 30 is pivoted by spring 32 to where it overlaps supine leg 38 of lever 34 and fixes it in place. Object 12 is thus blocked and cannot be withdrawn from receiving shaft 10 without application of force. The position of object 12 is detected indirectly via the position of armature 30 by sensor 21 and is indicated to a controller.

Releasing lever 34 is possible only by attraction of armature 30. In this case the fixing of lever 34 is cancelled and its latch 40 can slide out of annular groove 20 by withdrawing object 12, so that object 12 can then be fully withdrawn from receiving shaft 10.

In the position of object 12 inside of receiving shaft 10 illustrated in FIG. 1a, antenna coil 23 of the inbuilt transponder is also coupled to a coil 22 enclosing receiving shaft 10, by means of which reader 42 of the device can communicate with the transponder of object 12 using the transponder as an antenna. At the same time object 12 can be identified by data stored in a memory of the transponder. With several receiving shafts 10 it is possible to ascertain the position of receiving shaft 10 receiving object 12 with the transponder via each stationary coil 22 used for reading transponder data. It is also possible to ascertain the position via the position of armature 30 assigned to the receiving shaft by means of sensor 21.

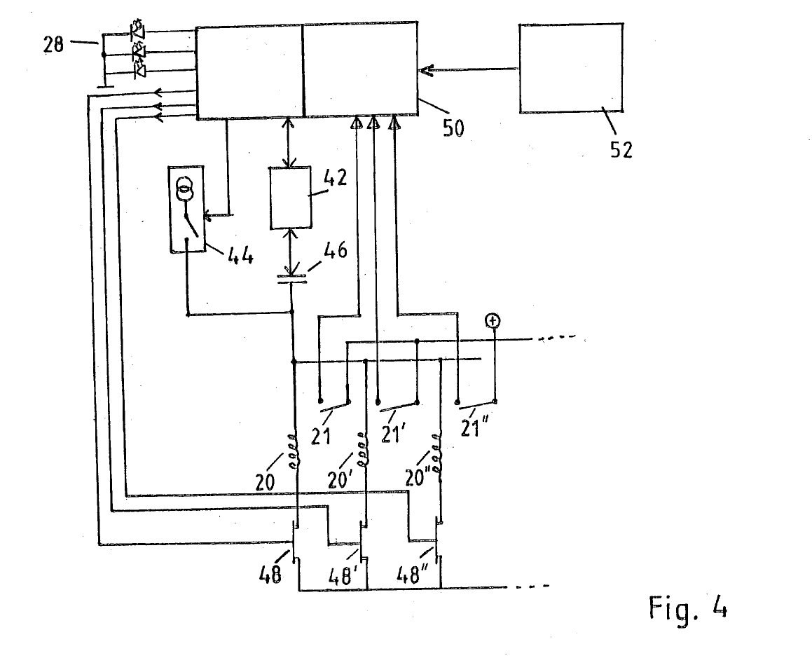

FIG. 4 illustrates a block circuit diagram of the electrical and electronic components of the device. It is assumed that the device has a number of receiving shafts 10 and a coil 22 is assigned to each receiving shaft 10. Coils 22 are interconnected at their hot ends. The common connecting point of coils 22 is also connected galvanically to a regulatable energy source 44 such as a controllable current source and coupled to a sender and receiver of a reader 42 inductively or via a capacitor 46. Coils 22 may be coupled galvanically to a direct-current or direct-voltage source or coupled galvanically or inductively to a low-frequency alternating-current or alternating-voltage source. The cold ends of coils 22 are connected via electronic switches 48 to a reference potential, whereby control inputs of electronic switches 48 lead to a controller 50, which forms a multiplexer together with electronic switches 48. Controller 50 also aids in evaluating and identifying transponder data and is accordingly connected to the sender and receiver of reader 42, and also with a control input of current source 44. Controller 50 can still be operated via an input device 52, for example via a keyboard and/or a reader for proof of authorization.

To identify objects 12 the antennae are coupled cyclically to reader 42 by means of the multiplexer. When an object 12 is inserted into receiving shaft 10 the transponder communicates with reader 42. At this point, the transponder is identified and is assigned to a receiving shaft 10 via each active coil 22 acting as antenna. In addition to this, the times at which an object 12 is introduced to a receiving shaft 10 and removed therefrom are also determined.

For an object 12 to be removed from receiving shaft 10 according to an authorization query, receiving shaft 10 is required to be unlocked. This can be done via the input device 52 by means of the keyboard alone or in combination with proof of authorization and badge reader. After this the responsible actuator is selected by the multiplexer and via a current source 44, coil 22 of each actuator is activated and locking is cancelled. Then object 12 can be removed from receiving shaft 10. Even this procedure is detected by reader 42, as soon as the transponder of object 12 is removed from the field of the antenna of reader 42 and communication is interrupted.

If object 12 is not removed from receiving shaft 10, then this case can be recognized by reader 42 and sensor 21 and object 12 can be relocked after a time delay.

When an object 12 is returned the transponder number of object 12 can first be read with reader 42. With sensor 21, the valid stopped position of object 12 is then detected and indicated to controller 50. Only when both events, namely “legible transponder number” by reader 42 and “stopped position” of object 12 by sensor 21, are recognized, does controller 50 announce no interference.

To optically signal the relevant receiving shaft 10 and to indicate correct stopping or interference, LEDs 28 are triggered by controller 50, which are assigned to each of the receiving shafts.

While only a few embodiments of the present invention have been shown and described, it is to be understood that many changes and modifications may be made thereunto without departing from the spirit and scope of the invention as defined in the appended claims.

What is claimed is:

1. A device for identifying and storing at least one object equipped with a transponder comprising:
(a) a reader comprising a sender and a receiver;
(b) a receiving shaft for the object having an antenna for said reader; and
(c) a locking device for said at least one object comprising an electromagnetic actuator and a regulatable energy source;
wherein said antenna and said electromagnetic actuator comprise a common coil coupled to said sender and said receiver of said reader and to said regulatable energy source of said electromagnetic actuator.

2. The device as claimed in claim 1 wherein:
(a) said energy source is selected from the group consisting of a direct-current source, a direct-voltage source, a low-frequency alternating-current source, and a low-frequency alternating-voltage source; and
(b) said coil is coupled to said energy source and is inductively or capacitively coupled to said sender and said receiver of said reader.

3. The device as claimed in claim 2, wherein said electromagnetic actuator comprises a single-aperture core arranged radially inside said coil, a yoke overlapping said coil and an armature magnetically attracting said yoke, wherein at least said single-aperture core and said yoke have peripheral interruptions.

4. The device as claimed in claim 3, wherein said locking device further comprises a pivoting lever with a latch, which:
(a) when the object is inserted into said receiving shaft, reaches a latch position in which said latch engages in a recess of the object, said armature gripping said lever in the latch position and fixing said lever in position, when said coil is in a magnetically inactive state; and
(b) reaches a release position when said armature is attracted so that withdrawal of the object detaches said latch from being engaged with the recess of the object.

5. The device as claimed in claim 4, wherein said armature pivots away from said yoke by gravity or spring force when said coil is in the magnetically inactive state.

6. The device as claimed in claim 4, wherein said lever pivots into a stable release position by gravity or spring force when in an unactuated or unfixed state.

7. The device as claimed in claim 1, wherein when said actuator is in a currentless or voltage-free state the locking device has stable states both in a release position and in a stop position.

8. The device as claimed in claim 1, wherein said locking device has a stable stop position when said actuator is in a currentless or voltage-free state, assumes a time-limited release position when said actuator is supplied with current or voltage, and automatically returns from said time-limited release position after a selected time period to said stop position.

9. The device as claimed in claim 1, wherein continual or intermittent communication of the transponder with the reader monitors object position in said receiving shaft.

10. The device as claimed in claim 4, wherein at least one sensor monitors at least one member selected from the group consisting of object position in said receiving shaft, lever position, and armature position.

11. The device as claimed in claim 1 further comprising a plurality of receiving shafts, a plurality of coils associated with said receiving shafts, and a multiplexer coupled to said coils comprising a controller and a plurality of electronic switches assigned to said coils, said coils being coupled by said multiplexer to said sender and said receiver of said reader and to said regulatable energy source.

12. The device as claimed in claim 11, wherein said receiving shafts have sensors coupled by said multiplexer to said sender and receiver and said regulatable energy source.

13. The device as claimed in claim 1, wherein the object is relocked upon remaining in said receiving shaft following a time delay after unlocking.

14. The device as claimed in claim 10, wherein said reader initially reads transponder number information from said receiving shaft, said sensor detects a stop position of the object, and the transponder number information and the position detected by the sensor is transferred to a controller.

15. The device as claimed in claim 14, wherein said controller generates a fault indication with an illegible transponder number or a non-stopped position of the object and does not generate a fault indication with both a legible transponder number and a stop position of the object.
